(19) United States
(12) Patent Application Publication
(10) Pub. No.: US 2007/0202379 A1
(43) Pub. Date: Aug. 30, 2007

(54) Fuel cell, refueling device for the fuel cell, and electronic device and fuel cell system include the fuel cell and refueling device

(76) Inventors: Ryuji Kohno, Kasumigaura (JP); Makoto Kitano, Tsuchiura (JP); Hayami Toba, Hitachinaka (JP); Miyuki Fukushi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/526,748

(22) Filed: Sep. 26, 2006

(30) Foreign Application Priority Data
Feb. 24, 2006 (JP) 2006-047730

(51) Int. Cl. H01M 8/02; H01M 8/04; B67D 5/08

(52) U.S. Cl. 429/34; 429/25; 222/55

(57) ABSTRACT

A fuel cell having a membrane electrode assembly to cause an electrochemical reaction in a fuel so as to generate electric power, a fuel holding body for holding the fuel to supply the fuel to the membrane electrode assembly, a fuel supply path to supply the fuel being pressurized to the fuel holding body and a fuel exhausting path to exhaust the fuel from the fuel holding body by using an internal pressure of the fuel.

### CLAIM OF PRIORITY

The present application claims priority from Japanese application serial no.2006-047730, filed on Feb. 24, 2006, the content of which is hereby incorporated by references into this application.

### BACKGROUND OF THE INVENTION

1. Field of the Technology

The present invention relates to a fuel cell, a refueling device for the fuel cell, and an electronic device and fuel cell system which each include the fuel cell and refueling device and, more particularly, to a fuel cell to which fuel can be supplied and from which remaining fuel can be exhausted easily, a refueling device for the fuel cell, and an electronic device and fuel cell system which each include the fuel cell and refueling device.

2. Background of Art

Recent direct methanol fuel cells (DMFCs), which directly use methanol (liquid fuel) to generate electric power, have attracted much attention as power supplies that enable mobile electronic devices, such as mobile personal computers, to be used continuously for a long period of time.

DMFCs are broadly classified into two types according to the method by which fuel is supplied to a membrane electrode assembly (MEA), which is the power generation medium of the DMFC; one uses an active method in which a pump and a fan are used to circulate fuel when fuel is supplied, and the other uses a passive method in which fuel is only supplied by gravity or natural convection without a fan or pump being used.

In the case of mobile electronic devices, DMFCs in the passive method are dominant in response to requests for compact, lightweight devices.

A conventional fuel cell in the passive method has at least a membrane electrode assembly and a fuel holding body for holding fuel to be supplied to the membrane electrode assembly. The fuel cell may have a refueling means for refueling the fuel holding body, as described in Patent Document 1.

DMFCs usually use a methanol solution as fuel. This type of fuel theoretically undergoes an electrochemical reaction on the membrane electrode assembly when the molar ratio of methanol to water is 1:1, generating electric power.

If a methanol solution with a high concentration is used as fuel, many methanol molecules pass through the membrane electrode assembly and lower reactivity on the air side (this phenomenon is referred to below as a crossover phenomenon), lowering a power generation efficiency. To avoid this, fuel is adjusted to a concentration range in which an optimum power generation efficiency is obtained (this range is referred to below as an appropriate concentration range) before being used in the fuel holding body.

Patent Document 1: Japanese Application Patent Laid-open Publication No. 2004-79506 (paragraph 0051 and FIG. 3)

### SUMMARY OF THE INVENTION

When a conventional fuel is used for a long period of time, it has been unavoidable for the methanol concentration of the fuel held in the fuel holding body to change, because fuel is consumed for power generation. To keep the fuel concentration in the fuel cell within the appropriate concentration range, it is necessary to supply fuel with a prescribed concentration according to the mass balance specific to the fuel cell.

The fuel cell described in Patent Document 1 is therefore provided with a refueling means. However, new fuel is supplied without fuel remaining in the fuel holding body (this type of fuel is referred to below as a drain) being discharged. This results in a mixture of the newly supplied fuel and the drain in the fuel holding body.

The present invention addresses the above problem with the object of providing a fuel cell in which fuel supply is performed properly when the fuel cell is refueled, a refueling device for the fuel cell, and an electronic device and fuel cell system which each include the fuel cell and refueling device.

A fuel cell of the present invention comprising a membrane electrode assembly to cause an electrochemical reaction in a fuel so as to generate electric power, a fuel holding body for holding the fuel to supply to the membrane electrode assembly, a fuel supply path to supply the fuel being pressurized to the fuel holding body and a fuel exhausting path to exhaust the fuel from the fuel holding body by pressure of the fuel being pressurized. Accordingly, when new fuel is resupplied, drain is discharged from an exhaust port (exhaust mechanism) of the fuel exhausting path.

According to the present invention, when fuel is supplied to the fuel cell through the fuel supply path, drain is discharged from the fuel exhausting path, achieving proper fuel supply. Even when fuel is resupplied repeatedly from the refueling device to use the fuel cell continuously for a long period of time, excessive changes in the fuel concentration can be avoided, improving the stability in power generation.

### BRIEF DESCRIPTION OF THE DRAWINGS

FIG. 1 is a structural diagram indicating a first embodiment of a fuel cell according to the present invention.

FIGS. 2A and 2B show the structure of the fuel cell of an embodiment of the present invention in detail.

FIG. 3 is a structural diagram indicating a second embodiment of a fuel cell according to the present invention.

FIGS. 4A and 4B show the fuel cell structure in detail and also illustrate the operation of the fuel cell of an embodiment of the present invention.

FIG. 5 is a structural diagram indicating a third embodiment of a fuel cell according to the present invention.

FIG. 6 is a structural diagram indicating that the fuel collecting chamber is separated from the refueling device of an embodiment of the present invention.

FIG. 7 illustrates how the fuel cell and refueling device of an embodiment of the present invention are used in a mobile personal computer.

FIG. 8 illustrates how the fuel cell and refueling device of an embodiment of the present invention are used in a mobile phone.

FIG. 9 illustrates the structure of the fuel cell of an embodiment of the present invention in detail.

### DETAILED DESCRIPTION OF THE INVENTION

Embodiments of the present invention will be described in with reference to the drawings.

### First Embodiment

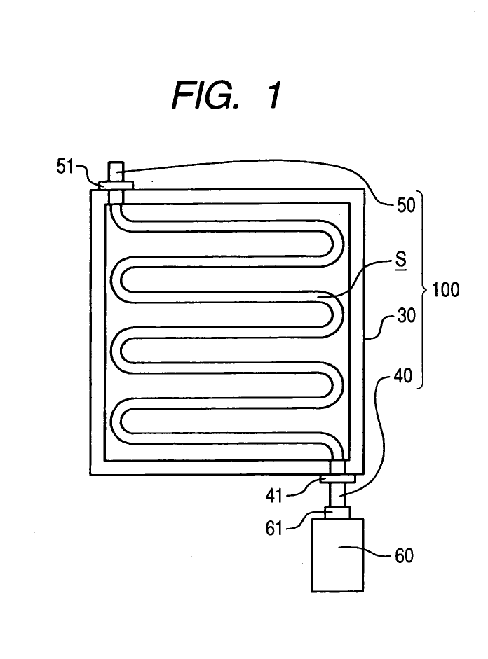

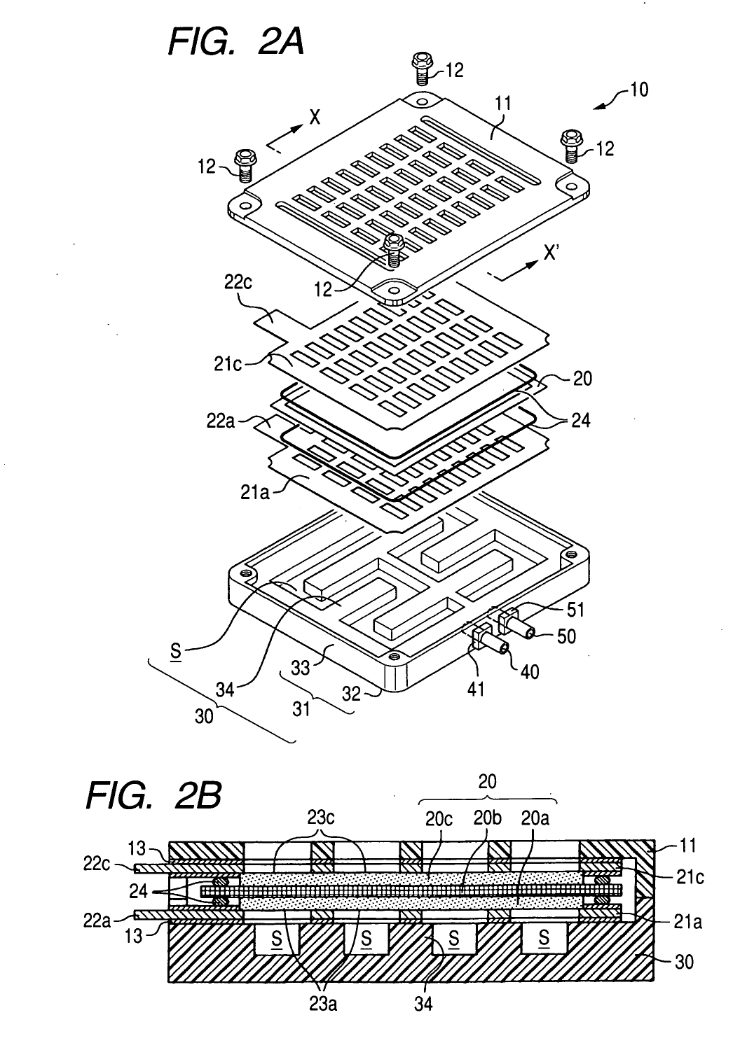

FIG. 1 is a structural diagram indicating a first embodiment of a fuel cell according to the present invention. A fuel section 100 of the fuel cell 10 (see FIG. 2) comprises a fuel holding body 30, a fuel supply path 40, a supply valve 41, a flow path S, an exhausting valve 51, and a fuel exhausting path 50. A refueling device 60 is detachably attached to the fuel supply path 40. The fuel cell 10 holds fuel in a flow path S disposed in the fuel holding body 30, and also supplies the fuel to a membrane electrode assembly 20 (see FIG. 2) to cause the fuel to undergo an electrochemical reaction so as to generate electric power.

The refueling device 60, detachably attached to the fuel supply path 40, has a function for expelling fuel by using an internal pressure. When the refueling device 60 is attached to the fuel supply path 40 for refueling, a refueling valve 61 of the refueling device 60 opens; when the refueling device 60 is detached from the fuel supply path 40, the refueling valve 61 closes.

The supply valve 41 disposed on the fuel supply path 40, by which one end of the fuel supply path 40 can communicate with the flow path S and the other end can be connected to the refueling device 60.

The supply valve 41 has a function that opens the supply valve so that when pressurized fuel is supplied from the refueling device 60 to the flow path S, the fuel can pass, and closes the supply valve in other cases to prevent the fuel from passing. An external command may be used to selectively open and close the supply valve 41.

One end of the fuel exhausting path 50, provided with the exhausting valve 51, communicates with one end of the flow path S which is opposite to the end to which the fuel supply path 40 is attached; the other end of the fuel exhausting path 50 is open toward the outside of the fuel holding body 30.

The exhausting valve 51 switches from a closed state to an open state when the value of a pressure to be applied to the fuel held in the flow path S becomes higher than a first threshold value; the exhausting valve 51 switches from the open state to the closed state when the pressure becomes lower than a second threshold value, which is lower than the first threshold value. The first threshold value is slightly lower than the pressure of the fuel to be resupplied, and the second threshold value is slightly higher the atmospheric pressure. The exhausting valve 51 may be automatically opened and closed in synchronization with the supply valve 41.

The supply valve 41 and exhausting valve 51 are not mandatory elements; they may be lids or plugs that can block the fuel supply path 40 and fuel exhausting path 50. Although the flow path S shown in the figure is snaky as an example of a flow path through which fuel (fluid) passes in one way, the flow path S may be turned. The flow path S suffices if it can supply fuel to the entire surface of an anode 20a (see FIG. 2) and exhaust fuel through an expelling flow. The fuel holding body 30 may have an extensive interior space. This is because when fuel is supplied, drain in the fuel holding body 30 is exhausted from the fuel exhausting path 50 and fuel is resupplied properly.

FIGS. 2A and 2B show the structure of the fuel cell in detail. As shown in FIG. 2A, the membrane electrode assembly (MEA) 20 is disposed between two current collecting plates, which are an anode current collecting plate 21a disposed on one surface of the membrane electrode assembly and a cathode current collecting plate 21c disposed on the opposite surface. The membrane electrode assembly 20 is fixed to the fuel holding body 30 by a holding plate 11 and fastening members 12, together with the current collecting plates, so that fuel can be supplied. As indicated by the cross section along line X-X′ in FIG. 2B, insulating films 13 are provided on a boundary between the anode current collecting plate 21a and the fuel holding body 30 and between the cathode current collecting plate 21c and the holding plate 11, so that they are not brought into electrical conduction.

The membrane electrode assembly 20 structured as described above causes the supplied fuel to undergo an electrochemical reaction to generate electric power, and externally outputs current from a negative terminal 22a extending from the anode current collecting plate 21a and a positive terminal 22c extending from the cathode current collecting plate 21c.

The membrane electrode assembly 20 comprises an electrolytic membrane 20b, an anode 20a, and a cathode 20c, the electrolytic membrane being disposed between the anode and the cathode as shown in FIG. 2B. Part of the anode 20a is exposed through a plurality of fuel holes 23a formed in the anode current collecting plate 21a.

Part of the cathode 20c is exposed through a plurality of oxygen holes 23c formed in the cathode current collecting plate 21c. The plurality of fuel holes 23a face the plurality of oxygen holes 23c on a one-to-one basis, through the electrolytic membrane 20b. Sealing members 24 are provided around the outer peripheries of the membrane electrode assembly 20 to prevent fuel supplied to the anode 20a from being entering the cathode 20c.

The anode 20a is a mixture of a catalyst and carbon powder that supports the catalyst, the catalyst comprising microscopic alloy particles made of ruthenium and platinum. When fuel (methanol and water) is supplied to the anode 20a, the fuel is oxidized and hydrogen ions and electrons are generated, as indicated by formula (1). The generated electrons move to the anode current collecting plate 21a and are externally emitted through the negative terminal 22a.

The electrolytic membrane 20b is made of, for example, polyperfluoro sulfonic acid resin. Specifically, Nafion (trademark), Aciplex (trademark), or the like is used. The electrolytic membrane 20b has a function that transfers the hydrogen ions generated at the anode 20a to the cathode 20c disposed on the opposite side but does not transfer the electrons.

The cathode 20c is a mixture of a catalyst and carbon powder that supports the catalyst, the catalyst comprising microscopic platinum particles. When electrons are supplied from the positive terminal 22c through the cathode current collecting plate 21c to the cathode 20c, oxygen that enters through the oxygen holes 23c are reduced and the reduced oxygen reacts with hydrogen ions transferred by the electrolytic membrane 20b, as indicated by formula (2), generating water.

The membrane electrode assembly 20 undergoes an electrochemical reaction so that methanol and water, constituting fuel, has a molar ratio of 1:1 to generate electric power, as indicated by formulas (1) and (2). The membrane electrode assembly then generates carbon dioxide as a by-product gas at the anode 20a and water as a by-product material at the cathode 20c, as indicated by formula (3). In practice, however, fuel consumed due to power generation by the fuel cell 10 does not have this theoretical ratio because water selectively passes through the membrane electrode assembly 20 in relation to the transfer of hydrogen ions. The amount of water selectively passing through the membrane electrode assembly 20 largely varies depending on the performance of the electrolytic membrane 20b and the usage environment.

Anode 20a: CH₃OH+H₂O→CO₂+6H⁺+6e⁻ (1)

Cathode 20c: 3/2O₂+6H⁺+6e⁻→3H₂O (2)

Total reaction: CH₃OH+3/2O₂→CO₂+2H₂O (3)

The fuel holding body 30 comprises a vessel 31 and partitioning block 34, as shown in FIG. 2A. The vessel 31 is structured so that fuel can be stored in a space formed by a bottom plate 32, which forms the bottom, and side plates 33, which are disposed around the outer periphery and form the sides.

The partitioning block 34 extends from the bottom plate 32 and side plates 33, and one end of the partitioning block supports the bottom side of the membrane electrode assembly 20 as shown in FIG. 2B. As described above, the partitioning block 34 partitions the space formed in the vessel 31 and forms a single sealed flow path S from the beginning point to the terminating point. When the flow path S is filled with fuel, the fuel is supplied to the membrane electrode assembly 20 and an electrochemical reaction is caused. The flow path S in FIG. 2A differs from the flow path S in FIG. 1 in that it is looped back.

To prevent the power generation efficiency from being lowered, the concentration of the fuel held in the fuel holding body 30 (or the flow path S) is adjusted so that a cross-over phenomenon, in which methanol that has passed through the membrane electrode assembly 20 lowers the activity on the cathode 20c side, does not occur. Specifically, fuel with a methanol concentration of about 10%, which is further lower than the concentration at the above theoretical ratio, is held in the fuel holding body 30.

When power generation is continued, the concentration of the fuel held in the fuel holding body 30 changes because the methanol and water are consumed at a fixed ratio. If this change in the concentration continues, the fuel held in the fuel holding body 30 falls outside the appropriate concentration range suitable for power generation, lowering the power generation efficiency of the fuel cell 10. The fuel outside the appropriate concentration range is drain.

The fuel supply path 40 extends through part of a side plate 33 near the beginning point of the flow path S, as shown in FIG. 2A, so that fuel can be supplied. The fuel supply path 40 is provided with a supply valve 41.

The fuel exhausting path 50 extends through part of the side plate 33, as shown in FIG. 2A, so that fuel can be exhausted near the terminating point of the flow path S. The fuel exhausting path 50 is provided with an exhausting valve 51.

When pressurized fuel is supplied to the fuel holding body 30, the pressure can be released immediately by the action of the exhausting valve 51. This reduces loads to the fuel holding body 30 and membrane electrode assembly 20. The fuel exhausting path 50 in FIG. 2A differs from the fuel exhausting path 50 in FIG. 1 in that it is disposed adjacent to the fuel supply path 40.

Next, operation will be described.

The refueling device 60 is attached to the fuel supply path 40 to resupply fuel. The refueling valve 61 of the refueling device 60 then opens, allowing fuel to be supplied under a prescribed pressure. When the value of the pressure to be applied to the fuel in the flow path S becomes higher than the first threshold value, the exhausting valve 51 switches from the closed state to the open state. When the exhausting valve 51 is opened, the drain in the flow path S is exhausted from the fuel exhausting path 50. Accordingly, the flow path S is filled with new fuel from the refueling device 60. When the refueling device 60 is detached from the fuel supply path 40, the refueling valve 61 closes and the supply valve 41 also closes. When the value of the pressure to be applied to the fuel in the flow path S becomes lower than the second threshold value, the exhausting valve 51 switches from the open state to the closed state.

As described above, in this embodiment, when the refueling device 60 is attached to the fuel supply path 40, the value of the pressure to be applied to the fuel in the fuel path S becomes large, causing the exhausting valve 51 to open. That is, the exhausting valve 51 has a drain exhausting function for exhausting drain. The fuel from the fuel supply path 40 thereby expels the drain in the flow path S in the direction in which the drain is exhausted, enabling the drain to be exhausted from the exhausting valve 51.

The flow path S only allows fuel to flow in a single path, so the fuel in the S flow path expels the drain in the direction in which the drain is exhausted, enabling the drain to be exhausted from the exhausting valve 51.

In this embodiment, although the exhausting valve 51 is controlled as a check valve that is opened and closed according to the values of the first and second threshold values, the open and close operations of the exhausting valve 51 may be controlled in synchronization with the open and close operations of the supply valve 41. Accordingly, when the refueling device 60 is attached to the fuel supply path 40, the exhausting valve 51 opens. The drain in the flow path S is then expelled by the fuel from the supply valve 41 and exhausted from the exhausting valve 51. The supply valve 41 and other valves may be passively operated by a rubber member, spring, or other elastic body, may operate actively, as with a solenoid, according to external signals or the like, or may be operated manually. This is also true for the valves described below.

### Second Embodiment

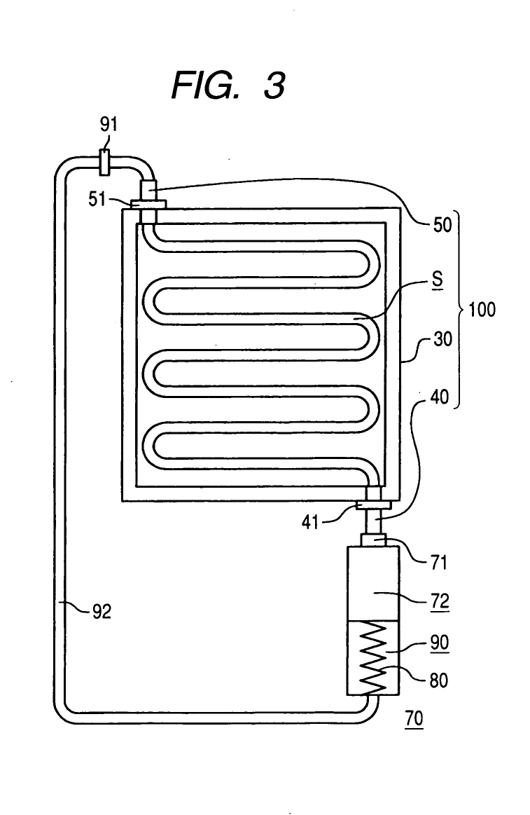

FIG. 3 is a structural diagram indicating a second embodiment of a fuel cell according to the present invention. The structure shown in FIG. 3 differs from the structure shown in FIG. 1 in that a means for collecting drain is added to a refueling device 70. The refueling device 70 comprises a refueling valve 71, a fuel storing chamber 72, a pressure applying means 80, a fuel collecting chamber 90, a collecting valve 91, and a fuel collecting path 92.

The fuel storing chamber 72 has a space for hermetically storing fuel to be resupplied to the fuel holding body 30 of the fuel cell 10; it is structured so that a pressure is applied to the stored fuel by the pressure applying means 80. The refueling valve 71 opens when the refueling device 70 is attached to the fuel supply path 40, and closes when the refueling device 70 is detached from the fuel supply path 40.

The fuel collecting chamber 90 has a space for collecting drain that is expelled by the pressure of the fuel resupplied through the refueling valve 71 and then exhausted from the fuel exhausting path 50. The fuel collecting path 92 is a fuel channel for communicating between the fuel exhausting path 50 and the fuel collecting chamber 90; the collecting valve 91 is disposed near the fuel exhausting path 50. The collecting valve 91 functions as a check valve that opens when pressure is applied to the fuel in the fuel exhausting path 50, so as to prevent the drain from flowing back to the fuel exhausting path 50.

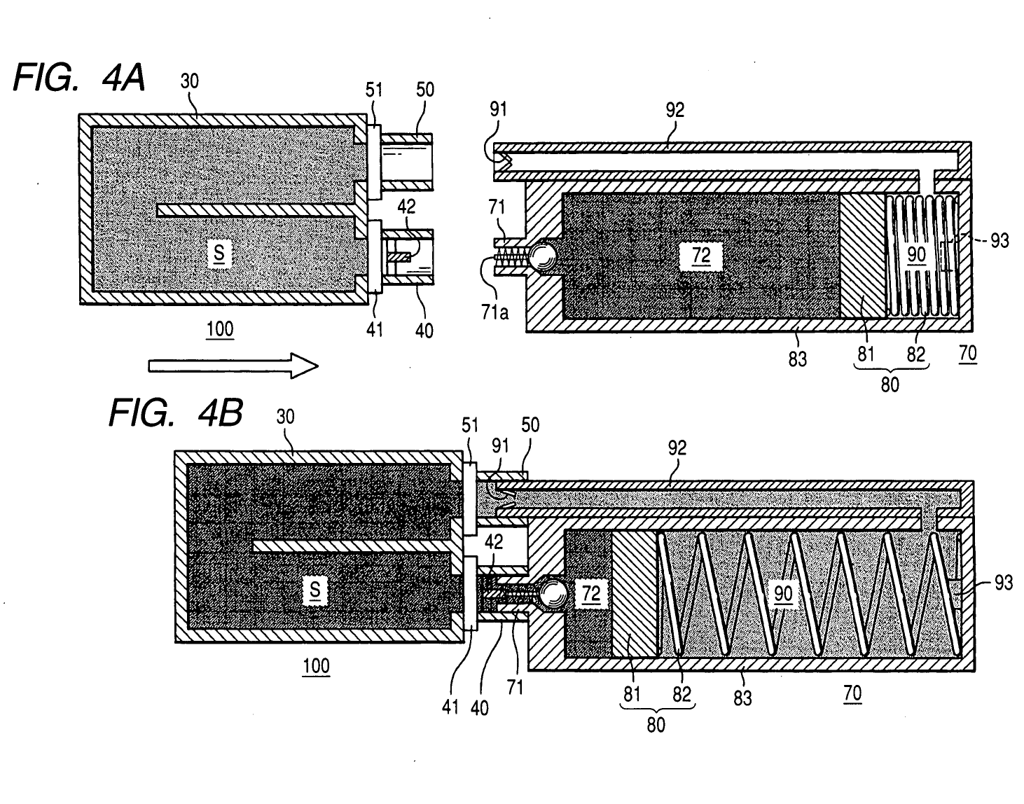

FIGS. 4A and 4B show the fuel cell structure in detail and also illustrate the operation of the fuel cell. FIG. 4A is cross-sectional views of the fuel section 100 and refueling device 70. The space in the case 83 of the refueling device 70 is divided by a movable partition 81 into two parts, forming the fuel storing chamber 72 and fuel collecting chamber 90. The refueling valve 71 is attached to one end of the fuel storing chamber 72. The end of the refueling valve 71 is structured so that it fits into the fuel supply path 40 of the fuel holding body 30.

The outer periphery of the movable partition 81 is in tight contact with the inner wall of the case 83; the movable partition 81 slides in one direction while maintaining the individual hermeticity of the fuel storing chamber 72 and fuel collecting chamber 90 partitioned by the movable partition 81. A pressure generating means 82 gives a pressure in the direction in which the movable partition 81 slides to reduce the volume of the fuel storing chamber 72. In FIG. 4A, an example of the pressure generating means 82 is, but not limited to, an elastic spring; anything may be used if it can provide a pressure required to slide the movable partition 81.

As the movable partition 81 moves, the fuel collecting chamber 90 is expanded by an amount by which the fuel storing chamber 72 is contracted. The fuel collecting path 92 is disposed in such a way that it can communicate with part of the case 83 to eliminate the hermeticity of the fuel collecting chamber 90. The end of the fuel collecting path 92 is structured so that it can fit into the fuel exhausting path 50 of the fuel holding body 30.

A coloring means 93 is disposed in the fuel collecting chamber 90 or fuel collecting path 92; it includes a pigment or dye that can be uniformly diffused in drain to color it. The drain collected in the fuel collecting chamber 90 is colored by the coloring means 93. Accordingly, when the volume of colored drain in the fuel collecting chamber 90 is compared with the volume of non-colored fuel in the fuel storing chamber 72, the amount of fuel remaining in the refueling device 70 can be easily checked from the ratio between the colored drain and the non-colored fuel.

Next, operation will be described.

When the refueling device 70 is attached to the fuel section 100 as shown in FIG. 4B, an end 71a of a guide bar of the refueling valve 71 is pressed against a projection 42 and the refueling valve 71 opens, allowing fuel to be supplied under a prescribed pressure. The supply valve 41 then opens. When the value of the pressure to be applied to the fuel in the flow path S held in the fuel holding body 30 becomes higher than the first threshold value, the exhausting valve 51 switches from the closed state to the open state. When the exhausting valve 51 opens, the drain in the flow path S is exhausted from the fuel exhausting path 50. The exhausted drain is collected in the fuel collecting chamber 90 through the collecting valve 91. Therefore, the flow path S is filled with new fuel from the fuel storing chamber 72.

When the refueling device 70 is detached from the fuel section 100, the end 71a of the guide bar of the refueling valve 71 is separated from the projection 42 and the refueling valve 71 closes. The supply valve 41 then closes. When the value of the pressure to be applied to the fuel in the flow path S held in the fuel holding body 30 becomes lower than the second threshold value, the exhausting valve 51 switches from the open state to the closed state.

According to the present invention, the refueling valve 71 switches between the open state and the closed state as the refueling device 70 is attached to and detached from the fuel section 100. When the refueling device 70 is attached to the fuel section 100, resupply of fuel starts; when the refueling device 70 is detached from the fuel section 100, the resupply stops. This simplifies fuel resupply work.

Alternatively, the refueling valve 71 may operate as follows; it opens when the refueling device 70 is attached to the fuel section 100, and switches to the closed state with the refueling device 70 left attached to the fuel section 100 if a prescribed condition is satisfied. Exemplary prescribed conditions include a time elapsed since the refueling valve 71 opens as well as information about variations in liquid pressure. The conditions are determined so that fuel is resupplied from the fuel storing chamber 72 by an amount approximately equivalent to the volume of the fuel holding body 30 for each switchover of the refueling valve 71 between the open state and the closed state. Accordingly, when the refueling device 70 is attached to the fuel section 100, fuel resupply and draining start; when an appropriate amount of fuel is resupplied (that is, drain is replaced with new fuel), the refueling valve 71 automatically closes. This further facilitates fuel resupply work and draining work.

In the refueling device 70, the collecting valve 91 may be structured, as is the refueling valve 71. Specifically, the arrangement of the refueling valve 71 and supply valve 41, in which when the refueling device 70 is attached to the fuel section 100 in the above example, the refueling valve 71 opens, may be applied as an arrangement of the exhausting valve 51 and 91. In this example, when the refueling device 70 is attached to the fuel section 100, the refueling valve 71, supply valve 41, exhausting valve 51, and collecting valve 91 all open at the same time. As a result, when fuel is supplied, drain is almost naturally opened, completing a process to replace drain with fuel in a very short time. This reduces extra work of a user who uses the device and practices the process, and also suppresses fuel and drain from being mixed with an elapse of time, which is efficient in maintaining the purity of newly supplied fuel.

If, in this embodiment, the maximum volume by which fuel can be stored in the fuel storing chamber 72 is substantially the same as the volume of the fuel that can be held in the fuel holding body 30, the refueling device 70 is emptied by a single resupply, making the refueling device 70 suitable for single-use applications in which fuel is resupplied in one time and drain is also exhausted in one time.

If the maximum volume of the fuel storing chamber 72 is an integer multiple of, at least twice, the volume of the fuel held in the fuel holding body 30, fuel resupply and drain exhaustion by the refueling device 70 can be executed a plurality of time.

In the case of the fuel storing chamber 72 which enables multiple fuel resupplies and drain exhaustions, the case 83 may be made of a transparent material and graduated in relation to the volume of the fuel that the fuel holding body 30 can hold, so that the fuel can be visually checked. If the case 83 is graduated as described above, the amount of remaining fuel can be checked from the liquid level of the held fuel. In addition, this type of case provides a measure for the amount of fuel to be resupplied when the drain held in the fuel holding body 30 is replaced with new fuel.

Furthermore, in this embodiment, the refueling valve 71 can be switched between the open state and the closed state when refueling is performed. With the refueling device 70 that can execute refueling a plurality of time, the refueling valve 71 enables the refueling device 70 to be attached to the fuel section 100 only when refueling is performed and to be left detached in other cases. Accordingly, with the refueling valve 71 closed, non-used fuel can be left held in the fuel storing chamber 72.

A projection 42 is provided in this embodiment. However, the supply valve 41 may have a projection operating means that can be manually operated. In this case, the refueling device 70 is left attached to the fuel section 100. When a button on the projection operating means is pressed at the time refueling is needed, the projection protrudes, opening the refueling valve 71. When the button on the projection operating means is pressed again, the projection retracts, closing the refueling valve 71.

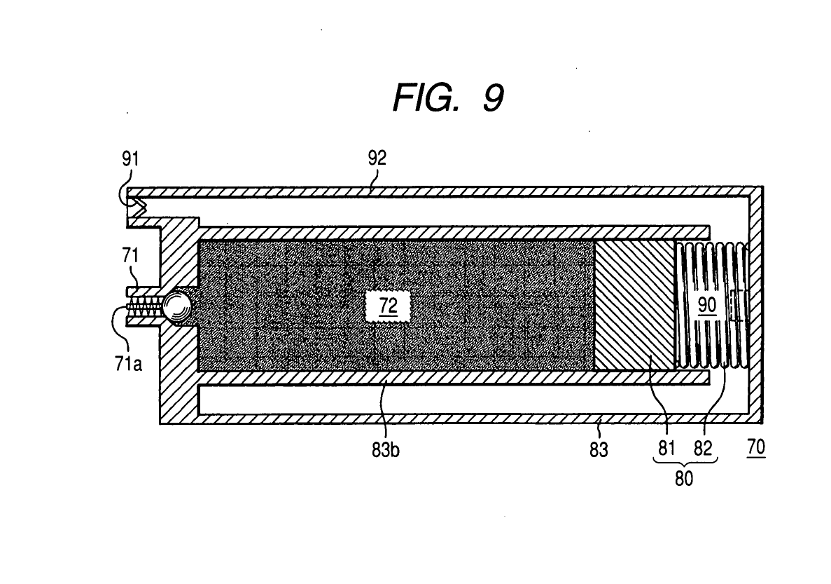

FIG. 9 illustrates the structure of the fuel cell in detail, showing a cross section of the refueling device 70. The refueling device 70 has another case 83b in the inner space of the case 83; one end of the case 83b being brought into contact with the front end of the refueling device 70 and the opposite end being separated from the back end of the refueling device 70. The case 83 and case 83b concentrically form dual cylinders. The movable partition 81 is disposed around the inner wall of the case 83b. The other elements are the same as in the embodiment shown in FIG. 4A. In this structure, the interior of the case 83b is the fuel storing chamber 72; a part between the case 83 and the case 83b and a part behind the movable partition 81 in the case 83b constitute a fuel collecting chamber. Operation in this structure is the same as described with reference to FIG. 4B. With this structure, since the surface of the refueling device 70 is a simple, approximate cylinder, it is easier to carry, store, and handle, and also improves the volumetric efficiency due to its compactness, as compared with the structure shown in FIG. 4A.

### Third Embodiment

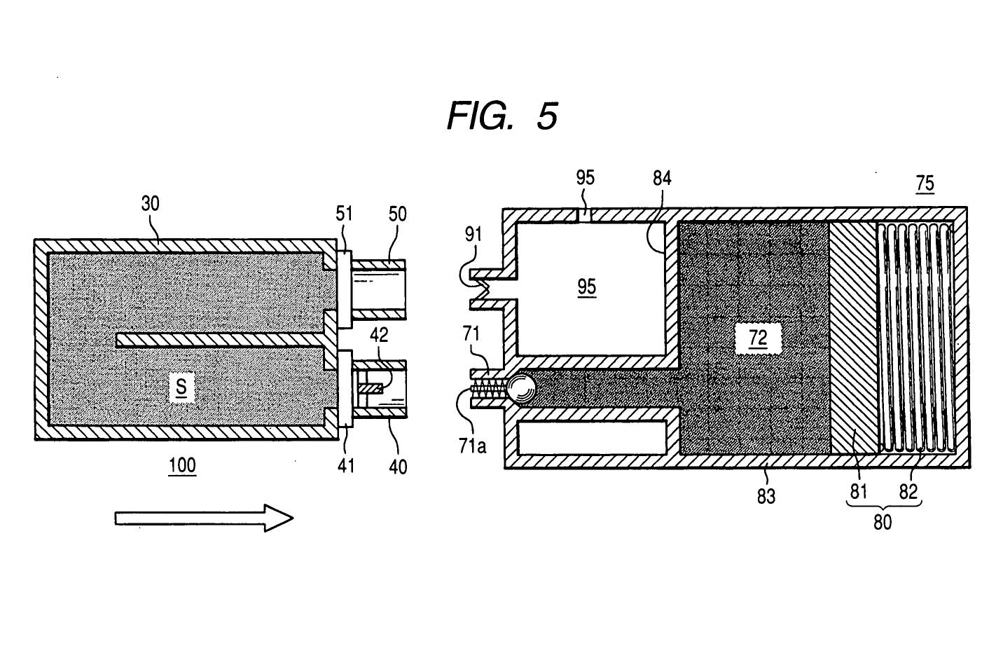

FIG. 5 is a structural diagram indicating a third embodiment of a fuel cell according to the present invention. The structure shown in FIG. 5 is a variation of the structure shown in FIGS. 4A and 4B; a fuel collecting chamber 95 having a different structure is disposed in a different place in the refueling device 75. The refueling device 75 is partitioned by a partition 84 disposed in the case 83 into the fuel storing chamber 72 and fuel collecting chamber 95.

The refueling valve 71 is attached to one end of the fuel storing chamber 72. The movable partition 81 slides while its outer periphery is in tight contact with the inner wall of the case 83. The pressure generating means 82 gives a pressure in the direction in which the movable partition 81 slides to reduce the volume of the fuel storing chamber 72.

A collecting valve 91 functioning as a check valve is provided at one end of the fuel collecting chamber 95. The fuel collecting chamber 95 is structured so that the volume is always kept constant; it has a vent hole 96 through which fuel sent through the collecting valve 91 is collected and air is released to the outside.

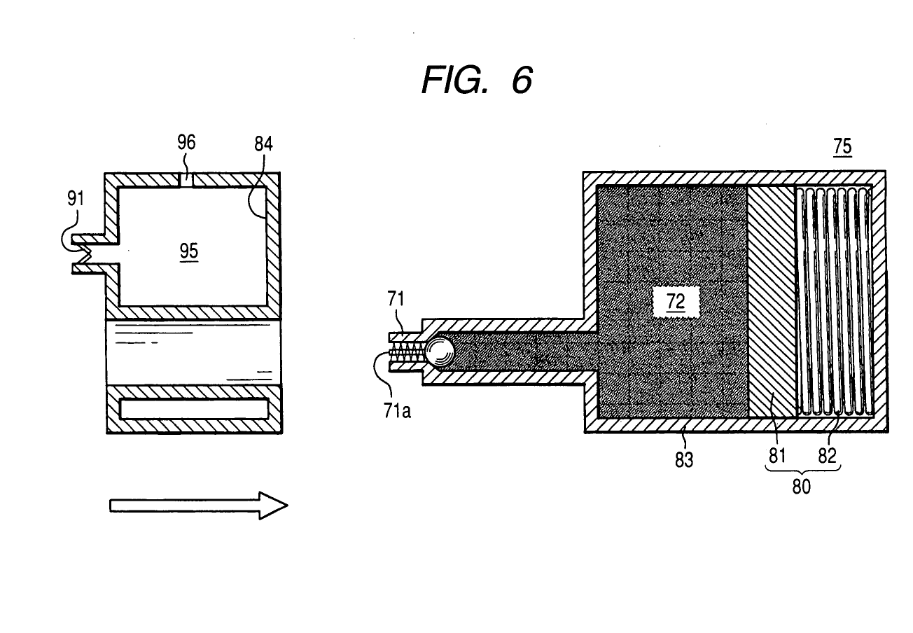

FIG. 6 is a structural diagram indicating that the fuel collecting chamber 95 is separated from the refueling device 75. In FIG. 5, the space in the fuel collecting chamber 95 is formed by the partition 84 disposed in the case 83, but the fuel collecting chamber 95 is preferably separated from the refueling device 75. In FIG. 6, the refueling device 75 can be reused just by replacing the fuel collecting chamber 95 including collected drain.

The structure of the fuel section 100 is identical to the structure shown in FIGS. 4A and 4B, to which the same reference numerals are assigned. The description of the structure has been already described, so it will be omitted here.

Next, operation will be described.

When the refueling device 75 is attached to the fuel section 100, an end 71a of a guide bar of the refueling valve 71 is pressed against a projection 42 and the refueling valve 71 opens, allowing fuel to be supplied under a prescribed pressure. The supply valve 41 then opens. When the value of the pressure to be applied to the fuel in the flow path S held in the fuel holding body 30 becomes higher than the first threshold value, the exhausting valve 51 switches from the closed state to the open state. When the exhausting valve 51 opens, the drain in the flow path S is exhausted from the fuel exhausting path 50. The exhausted drain is collected in the fuel collecting chamber 95 through the collecting valve 91. Therefore, the flow path S is filled with new fuel from the fuel storing chamber 72.

When the refueling device 75 is detached from the fuel section 100, the end 71a of the guide bar of the refueling valve 71 is separated from the projection 42 and the refueling valve 71 closes. The supply valve 41 then closes. When the value of the pressure to be applied to the fuel in the flow path S held in the fuel holding body 30 becomes lower than the second threshold value, the exhausting valve 51 switches from the open state to the closed state.

In this embodiment, the fuel collecting chamber 95 is separated from the fuel storing chamber 72. Accordingly, as shown in FIG. 6, after drain is collected in the fuel collecting chamber 95, the refueling device 75 can be reused just by replacing the fuel collecting chamber 95 with a new fuel collecting chamber 95.

Next, electronic devices that include the fuel cell and refueling device according to the embodiments of the present invention will be described. Specifically, a mobile personal computer and mobile phone are used as examples of the electronic devices.

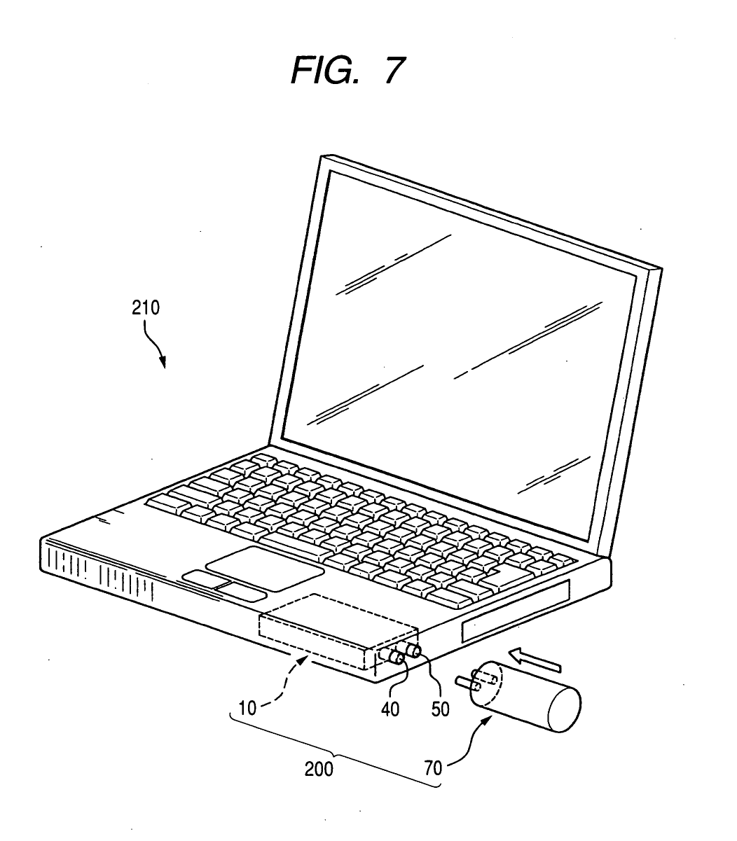

FIG. 7 illustrates how the fuel cell and refueling device are used in a mobile personal computer. The mobile personal computer 210 uses the fuel cell 10 and refueling device 70 according to the present invention as a power supply. In FIG. 7, the refueling device 70 is attached to the fuel cell 10 when fuel is resupplied. After fuel has been resupplied, the refueling device 70 may be detached. Alternatively, the refueling device 70 may be left attached.

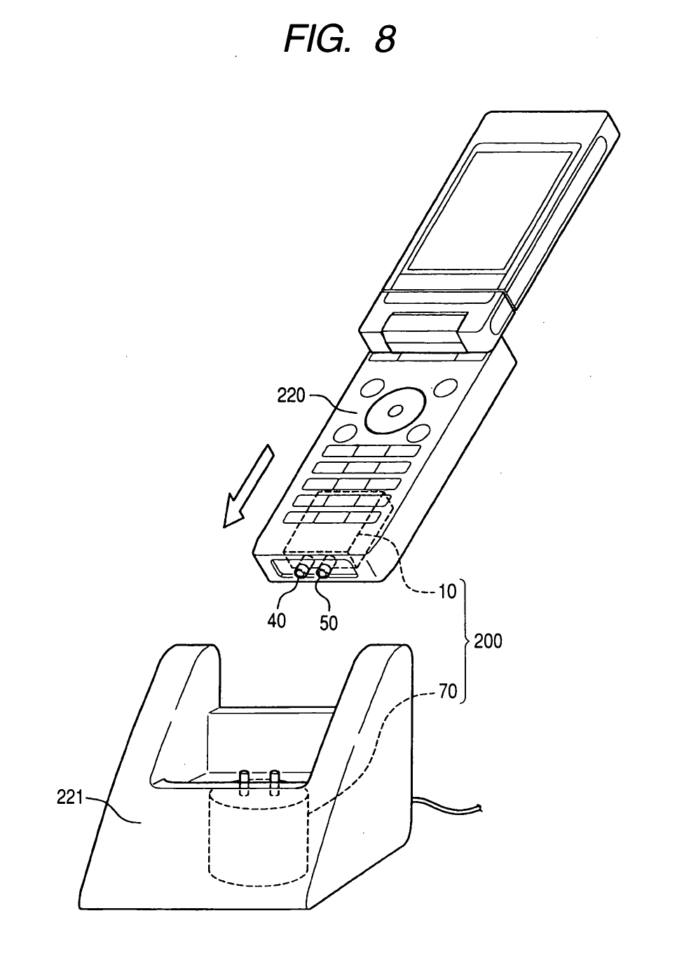

FIG. 8 illustrates how the fuel cell and refueling device are used in a mobile phone. The refueling device 70 is structured so that it is attached in a supporting case 221 and used as a stationary device. The fuel cell 10 is disposed in the mobile telephone 220. When the mobile telephone 220 is refueled, the mobile telephone 220 is placed on the supporting case 221 so as to be connected to the refueling device 70.

Mobile electronic devices as described above are used in various environments, so the ratio between consumed methanol and water changes and the fuel held in the fuel cell 10 readily falls outside the appropriate concentration range, lowering the power generation efficiency.

If the power generation efficiency is lowered as described above, however, when fuel is resupplied from the refueling device 70 and drain held in the fuel cell 10 is exhausted, the power generation efficiency is restored. The electronic device 110 can thereby continue to be in use.

Accordingly, a fuel cell 10, a refueling device for the fuel cell, and a fuel cell system 200 comprising the fuel cell 10 and its counterpart refueling device 70, can stably generate electric power for a long period of time, enabling the electronic device including them to be used for an extended period. Furthermore, if the refueling device 70 is structured so that it can be detachably attached to the fuel cell 10, the electronic device can be made compact.

What is claimed is:

1. A fuel cell having a membrane electrode assembly to cause an electrochemical reaction in a fuel so as to generate electric power, a fuel holding body for holding the fuel to supply the fuel to the membrane electrode assembly, a fuel supply path to supply the fuel being pressurized to the fuel holding body and a fuel exhausting path to exhaust the fuel from the fuel holding body by using an internal pressure of the fuel.

2. A fuel cell according to claim 1, further comprising a flow path to communicate the fuel supply path with the fuel exhausting path, a supply valve disposed on the fuel supply path to open and close selectively, and an exhausting valve disposed on the fuel exhausting path to open and close selectively.

3. A fuel cell according to claim 2, wherein the exhausting valve switches from a closed state to an open state when the value of a pressure to be applied to the fuel in the fuel exhausting path becomes higher than a prescribed first control value, and switches from the open state to the closed state when the value of the pressure to be applied to the fuel becomes lower than a prescribed second control value, which is lower than the first control value.

4. An electronic device in which the fuel cell according to any one of claim 1 to claim 3 is mounted.

5. A refueling device for a fuel cell having a membrane electrode assembly to cause an electrochemical reaction in a fuel so as to generate electric power, a fuel holding body for holding the fuel to supply the fuel to the membrane electrode assembly, a fuel storing chamber for storing the fuel to be resupplied to the fuel cell, a pressure applying device for giving a pressure to the fuel stored in the fuel storing chamber, a refueling valve disposed at one end of the fuel storing chamber to open and close selectively, a fuel collecting chamber for collecting the fuel exhausted from the fuel holding body by being expelled the fuel resupplied through the refueling valve, a fuel collecting path for collecting into the fuel collecting chamber the fuel exhausted from the fuel holding body, and a fuel collecting valve for selectively opening and closing the fuel collecting path.

6. A refueling device according to claim 5, wherein the pressure applying device has a movable partition to divide the fuel storing chamber and the fuel collecting chamber therein and moves in a direction in which the pressure is applied, and a pressure generating device to generate pressure.

7. A refueling device for a fuel cell having a membrane electrode assembly to cause an electrochemical reaction in a fuel so as to generate electric power, a fuel holding body for holding the fuel to supply the fuel to the membrane electrode assembly, a fuel storing chamber for storing the fuel to be resupplied to the fuel cell, a pressure applying device for giving a pressure to the fuel stored in the fuel storing chamber, a refueling valve disposed at one end of the fuel storing chamber to open and close selectively, a fuel collecting chamber for collecting the fuel exhausted from the fuel holding body by being expelled the fuel resupplied through the refueling valve, and a fuel collecting valve for selectively opening and closing the fuel collecting path.

8. A refueling device according to claim 7, wherein the fuel collecting chamber is capable of being attached and detached.

9. A refueling device according to any one of claim 5 to claim 8, wherein:
a volume for storing the fuel in the fuel storing chamber is approximately an integer multiple of the volume of the fuel stored in the fuel holding body;
the fuel in the fuel storing chamber is capable of being visually checked; and the fuel storing chamber is graduated in relation to the volume of the fuel holding body.

10. A refueling device according to any one of claim 5 to claim 8, wherein:
a volume for storing the fuel in the fuel storing chamber is approximately an integer multiple of the volume of the fuel stored in the fuel holding body; and
an amount of the fuel resupplied from the fuel storing chamber in one time is adjusted in relation to the volume of the fuel holding body.

11. A refueling device according to any one of claim 5 to claim 10, wherein the refueling valve is selectively opened and closed while being attached to the fuel cell.

12. A refueling device according to any one of claim 5 to claim 10, wherein the refueling valve is opened when it is attached to the fuel cell, and closed when it is detached from the fuel cell.

13. A refueling device according to any one of claim 5 to claim 12, wherein a coloring device for coloring the fuel to be collected into the fuel collecting chamber is provided.

14. An electronic device, including the refueling device for a fuel cell according to any one of claim 5 to claim 13.

15. A fuel cell system, comprising: a fuel cell according to any one of claim 1 to claim 3; and a refueling device for a fuel cell according to any one of claim 5 to claim 13.

16. A fuel cell system according to claim 15, wherein the refueling device is left attached to the fuel cell.

17. A fuel cell system according to claim 15, wherein the refueling device is a detachable device to be attached only when the fuel cell is refueled with the fuel.

18. A fuel cell system according to claim 17, wherein the refueling device is structured as a stationary device, the fuel cell being placed on the refueling device when the fuel cell is refueled with the fuel.
